(19) United States
(12) Patent Application Publication
(10) Pub. No.: US 2026/0056103 A1
(43) Pub. Date: Feb. 26, 2026

(54) TEST METHOD FOR ANTI-SLIP LONG EFFECTIVENESS OF ANTI-SLIP CERAMIC TILE

(71) Applicants: DONGGUAN CITY WONDERFUL CERAMICS INDUSTRIAL PARK CO., LTD., Dongguan (CN); MARCOPOLO HOLDINGS CO., LTD., Dongguan (CN)

(72) Inventors: Zhengqiang SHENG, Dongguan (CN); Jiaqi HUANG, Dongguan (CN); Zhanwen GU, Dongguan (CN); Kehui LIN, Dongguan (CN); Yuezeng XIE, Dongguan (CN); Duanxu CAO, Dongguan (CN); Yongqiang WANG, Dongguan (CN); Zhanhao CHEN, Dongguan (CN); Xuebin LIU, Dongguan (CN); Daocong HUANG, Dongguan (CN); Zhiyong OU, Dongguan (CN); Hanling YANG, Dongguan (CN)

(73) Assignees: DONGGUAN CITY WONDERFUL CERAMICS INDUSTRIAL PARK CO., LTD., Dongguan (CN); MARCOPOLO HOLDINGS CO., LTD., Dongguan (CN)

(21) Appl. No.: 18/931,579

(22) Filed: Oct. 30, 2024

(30) Foreign Application Priority Data
Aug. 23, 2024 (CN) 202411165434.7

(51) Int. Cl. G01N 3/56; E04F 15/08

(52) U.S. Cl. CPC G01N 3/56; E04F 15/082

(57) ABSTRACT

A test method for anti-slip long effectiveness of an anti-slip ceramic tile. The test method includes: performing a wear test on a testing surface of a to-be-tested anti-slip ceramic tile; performing an anti-slip performance test on the worn testing surface, to obtain a wear test value; and determining an anti-slip long effectiveness grade of the to-be-tested anti-slip ceramic tile according to the wear test value. In the embodiments, the worn to-be-tested anti-slip ceramic tile is subjected to the anti-slip performance test, to obtain the anti-slip long effectiveness grade, thus explaining the performance of the worn anti-slip ceramic tile, which is conductive to determining the long effectiveness anti-slip performance of the anti-slip ceramic tile, and provides the long effectiveness anti-slip performance test method and determination basis for the manufacturing of the anti-slip ceramic tile.

### CROSS-REFERENCE TO RELATED APPLICATIONS

The application claims priority of Chinese Patent Application Number 2024111654347, filed on Aug. 23, 2024, which is incorporated herein by reference in its entireties.

### TECHNICAL FIELD

The present disclosure relates to the technical field of ceramics, and in particular to a test method for anti-slip long effectiveness of an anti-slip ceramic tile.

### BACKGROUND

Architectural ceramic tiles are mainly used for walls and floors of home spaces, and have the function of easy cleaning and beautiful decoration. However, with the improvement of people's living standards, consumers have put forward higher requirements on the function of the ceramic tiles, and the relatively high anti-slip performances of the floor ceramic tiles are required for some decorative spaces.

The anti-slip tile in the market has many types, and can be classified into a mold anti-slip tile, a glaze anti-slip tile, a dry grain anti-slip tile and a post-processing anti-slip tile according to the technology mode. To improve the anti-slip performance of the product, manufacturing enterprises often compound and superpose multiple technologies for improving the anti-slip performance of the ceramic tile, to improve the anti-slip performance of the ceramic tile from many perspectives and many aspects. For example, uneven molds are combined with the anti-slip glaze and anti-slip dry grain, and some manufacturing enterprises adopt the combination of the anti-slip glaze with later anti-slip liquid, the combination of the uneven molds with the anti-slip liquid, the combinations of mold surfaces with a later processing broach, and other methods.

No matter which process technology is used to improve the anti-slip function of the ceramic tile or improve the body feel of comfort, the process technology will face a practical problem once being used, that is, after the anti-slip ceramic tile is used for a period of time, the surface thereof will have a certain degree of wear, and in particular the wear in entrances and exits of public places and other areas is more severe. The anti-slip ceramic tile product will be affected to some extent in the anti-slip function after being used for a period of time, even some ceramic tiles adopting the anti-slip technology have very high original anti-slip safety performance, but the anti-slip function disappears after a short period of application and wear, which seriously affects consumers' credibility to the anti-slip ceramic tile, and also brings physical or mental injuries to the consumers. The promotion and use of the anti-slip ceramic tile are affected to some extent, and the confusion that the consumers choose what kind of anti-slip ceramic tile is also brought.

Currently, in the ceramic industry, the performance indexes for the anti-slip ceramic tile are all obtained after the unworn anti-slip ceramic tile is subjected to the anti-slip test but the worn anti-slip ceramic tile is not subjected to performance test, thus not explaining the performance of the worn anti-slip ceramic tile, which is not conductive to the improvement and rational utilization of the anti-slip ceramic tile.

Therefore, the prior art exists defects, and needs to be improved and developed.

### SUMMARY

The technical problem to be solved by the present disclosure lies in providing a test method for anti-slip long effectiveness of an anti-slip ceramic tile in view of the above defects in the prior art, so as to solve the problem that a method for testing the performance of a worn anti-slip ceramic tile is not available in the prior art, thus not evaluating the performance of the worn anti-slip ceramic tile, which is not conductive to the improvement and rational utilization of the anti-slip ceramic tile.

The technical solution adopted to solve the technical problem in the present disclosure is as follows:

Embodiments of the present disclosure provide a test method for anti-slip long effectiveness of an anti-slip ceramic tile, and the method includes:

performing a wear test on a testing surface of a to-be-tested anti-slip ceramic tile;
performing an anti-slip performance test on the worn testing surface, to obtain a wear test value; and
determining an anti-slip long effectiveness grade of the to-be-tested anti-slip ceramic tile according to the wear test value.

Alternatively, before performing the wear test on the testing surface of the to-be-tested anti-slip ceramic tile, the method further includes:
horizontally placing the to-be-tested anti-slip ceramic tile on a test board in a manner of the testing surface facing upwards; and
performing an anti-slip performance test on the testing surface by using a pendulum method, to obtain an initial pendulum value; or performing an anti-slip performance test on the testing surface by using a sliding friction method, to obtain an initial sliding friction value.

Alternatively, the test method for the anti-slip long effectiveness of the anti-slip ceramic tile further includes:
formulating a wear anti-slip long effectiveness grading table in advance;
where the wear anti-slip long effectiveness grading table includes a plurality of anti-slip long effectiveness grade codes, as well as wear test threshold scopes and numbers of wear that correspond to the anti-slip long effectiveness grade codes.

Alternatively, the performing the wear test on the testing surface of the to-be-tested anti-slip ceramic tile includes:
performing a wear test on the testing surface of the to-be-tested anti-slip ceramic tile according to a sequence of the number of wear in the wear anti-slip long effectiveness grading table from small to large under a preset wear pressure; and
where the anti-slip long effectiveness grade codes are ranked according to the sequence of the number of wear from small to large.

Alternatively, the determining the anti-slip long effectiveness grade of the to-be-tested anti-slip ceramic tile according to the wear test value includes:
searching the wear anti-slip long effectiveness grading table, and determining a target anti-slip long effectiveness grade code and a target wear test threshold scope that correspond to the current number of wear in the wear anti-slip long effectiveness grading table;
where if the wear test value is within the target wear test threshold scope, the target anti-slip long effectiveness grade code and the current number of wear are recorded as the anti-slip long effectiveness grade of the to-be-tested anti-slip ceramic tile.

Alternatively, after searching the wear anti-slip long effectiveness grading table, and determining the target anti-slip long effectiveness grade code and the target wear test threshold scope that correspond to the current number of wear in the wear anti-slip long effectiveness grading table, the method further includes:
the number of wear corresponding to the next anti-slip long effectiveness grade code serving as a target number of wear if the wear test value is higher than the target wear test threshold scope;
performing the wear test on the testing surface of the to-be-tested anti-slip ceramic tile until to reach the target number of wear under the preset wear pressure; and
performing an anti-slip performance test on the testing surface of the to-be-tested anti-slip ceramic tile that reaches the target number of wear.

Alternatively, after searching the wear anti-slip long-lasting grading table, and determining the target anti-slip long-lasting grade code and the target wear test threshold scope that correspond to the current number of wear in the wear anti-slip long-lasting grading table, the method further includes:
recording the target anti-slip long effectiveness grade code and the previous number of wear of the current number of wear as the anti-slip long effectiveness grade of the to-be-tested anti-slip ceramic tile if the wear test value is lower than the target wear test threshold scope.

Alternatively, the wear anti-slip long effectiveness grading table includes: a wear anti-slip long effectiveness grading table corresponding to a pendulum method test and/or a wear anti-slip long effectiveness grading table corresponding to a sliding friction method test.

Alternatively, the wear anti-slip long effectiveness grading table further includes: an anti-slip long effectiveness ability and/or a wear equivalent determination result corresponding to the anti-slip long effectiveness grade code.

Alternatively, the performing the anti-slip performance test on the worn testing surface, to obtain the wear test value includes:
performing an anti-slip performance test on the worn testing surface by using a pendulum method, to obtain a wear pendulum value;
or, performing an anti-slip performance test on the worn testing surface by using a sliding friction method, to obtain a wear sliding friction value.

The present disclosure provides the test method for the anti-slip long effectiveness of the anti-slip ceramic tile, including: performing the wear test on the testing surface of the to-be-tested anti-slip ceramic tile; performing the anti-slip performance test on the worn testing surface, to obtain the wear test value; and determining the anti-slip long effectiveness grade of the to-be-tested anti-slip ceramic tile according to the wear test value. In the present disclosure, the worn to-be-tested anti-slip ceramic tile is subjected to the anti-slip performance test, to obtain the anti-slip long effectiveness grade, thus explaining the performance of the worn anti-slip ceramic tile, which is conductive to the improvement and rational utilization of the anti-slip ceramic tile.

### BRIEF DESCRIPTION OF THE DRAWINGS

FIG. 1 is a flowchart of a preferred embodiment of a test method for anti-slip long effectiveness of an anti-slip ceramic tile in the present disclosure.

FIG. 2 is a flowchart for testing and determining anti-slip long effectiveness of an anti-slip ceramic tile in the present disclosure.

FIG. 3 is a schematic diagram of a worn surface tested by a pendulum method.

FIG. 4 is a standard table for determining an anti-slip grade by a pendulum method (wet state).

FIG. 5 is a schematic structural diagram of an accelerated wear device for a ceramic tile.

FIG. 6 is a cooperation schematic diagram of an X-axis drive mechanism, a Z-axis drive mechanism and a rotary friction mechanism of an accelerated wear device for a ceramic tile.

FIG. 7 is a structural exploded diagram of an accelerated wear device for a ceramic tile in a first perspective.

FIG. 8 is a structural exploded diagram of an accelerated wear device for a ceramic tile in a second perspective.

FIG. 9 is a complete assembly schematic diagram of an accelerated wear device for a ceramic tile.

### DETAILED DESCRIPTION OF THE EMBODIMENTS

In order to make the objectives, technical solution and advantages of the present disclosure clearer and definer, the embodiments of the present disclosure will be described in detail below in conjunction with the drawings. It is understood that the specific embodiments described herein are merely used for explaining the present disclosure, instead of limiting the present disclosure.

How to evaluate and test whether anti-slip ceramic tiles, applied for a period of time in a practical space, can also continue to remain the anti-slip performance or how to determine the anti-slip safety thereof is very important. Currently, the technology and method for evaluating the anti-slip long effectiveness of the used ceramic tile rapidly are not yet available in the architectural ceramics industry. Both the wear-resisting grade and wear volume currently adopted by the ceramic tile cannot simulate the practical application phenomenon well, the grade determination has great relations with the product color, the wear material used by the wear volume is not in line with the practical life, and after the wear test, the change of the surface part of the ceramic tile before and after the test cannot also be tested accurately by the existing anti-slip detection method.

In view of the deficiencies in the prior art, an evaluation method for rapidly testing anti-slip long effectiveness of the used anti-slip ceramic tile is urgently needed, which is convenient to determine the anti-slip long effectiveness of the anti-slip technology by the manufacturing enterprises, for ease of manufacturing the most suitable product to guide applicable places, serve consumers, guide the industry and standardize the classification of the process special effects of the anti-slip ceramic tile, and distinguish which process of ceramic tiles have the anti-slip long effectiveness and the anti-slip long effectiveness grade evaluation. The anti-slip long effectiveness of the anti-slip ceramic tile in the present disclosure means that the surface of the ceramic tile exists certain wear after a period of use, but the ceramic tile can still remain the relatively high anti-slip performance.

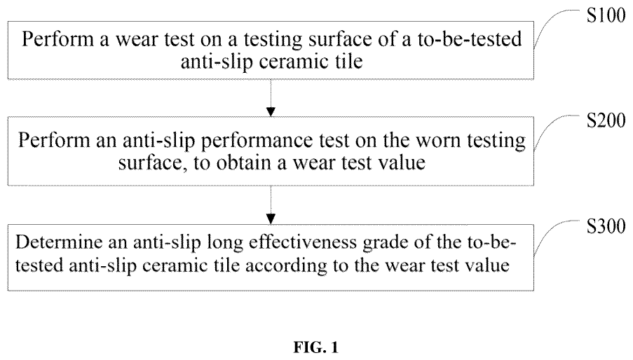

The present disclosure provide a test method for anti-slip long effectiveness of an anti-slip ceramic tile, as shown in FIG. 1, the test method for the anti-slip long effectiveness of the anti-slip ceramic tile includes:
step S100: performing a wear test on a testing surface of a to-be-tested anti-slip ceramic tile;

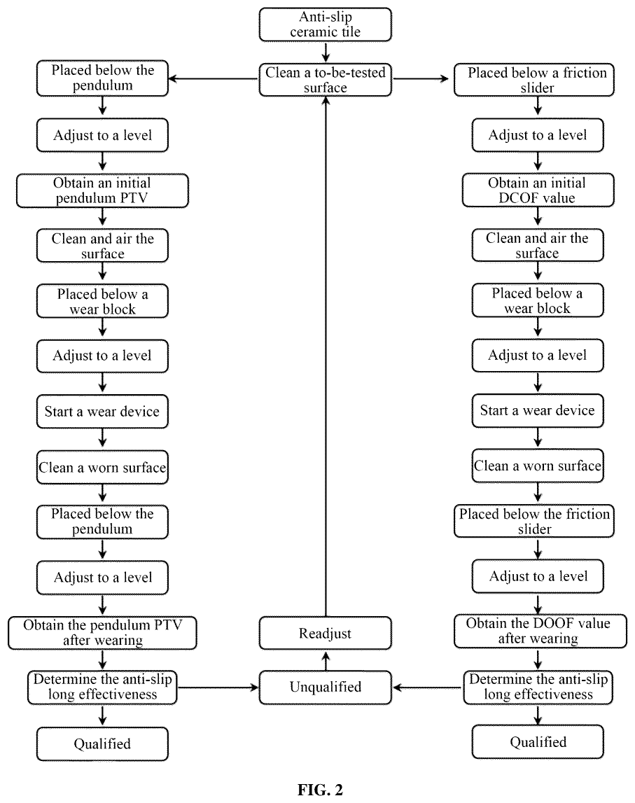

Specifically, as shown in FIG. 2, an anti-slip tile sample with a known pendulum value is cleaned, a surface of the sample is to be aired, the aired anti-slip tile sample is placed in a to-be-tested sample placement area of an accelerated wear device in a manner of the to-be-worn surface facing upwards, the number of wear of a reciprocating linear wear motion is set according to the counterweight pressure standard of the accelerated wear device, the accelerated wear device is started until the number of wear reaches the set number, and the device stops moving automatically. The accelerated wear device is provided with a counterweight, and the purpose of the counterweight is to increase the positive pressure on surfaces of the wear material and the to-be-tested ceramic tile, to achieve the effect of improving and accelerating the wear.

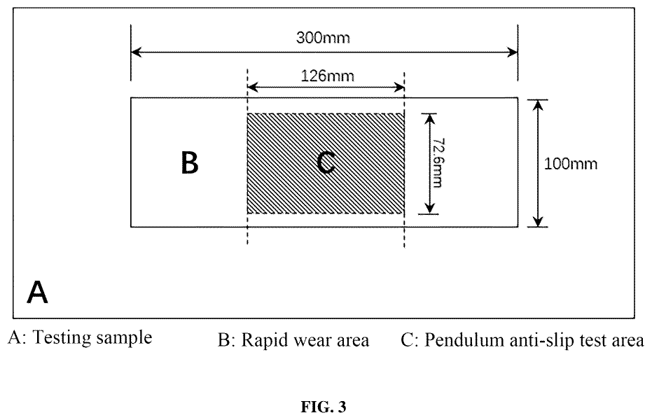

In one embodiment, when performing the wear test, a Scotch Brite ultra-fine cleaning pad is selected as the wear material, with a wear counterweight of 1 kg, a reciprocating frequency of 5,000 times, a wear area of 100 mm×300 mm, and an abrasive block size of 50 mm×100 mm, and after the wear, the anti-slip performance test area is the 72.6 mm×126 mm area in the middle of a wear area, as shown in FIG. 3. The reciprocating linear wear motion means that a slider mounted with the wear material makes a reciprocating motion on a testing surface, with the counting of 1; and a counter may set the reciprocating frequency of the reciprocating wear required, and each reciprocating motion is counted by the counter until the reciprocating wear motion stops when the set numerical value is reached.

In the existing method for determining the wear resistance of the anti-slip tile, the glazed tile standard test and the unglazed tile standard test are adopted, and the wear mechanism thereof is obviously different from the standard for evaluating the result. Even though the anti-slip tile of these two technologies may be used for the same area, this is not conductive to comparing the performances of the glazed product and the unglazed product. In addition, the existing test method for evaluating the wear resistance of the ceramic tile is not suitable for evaluating the anti-slip long effectiveness use of the product, with the main reasons as follows:

First, the mechanism and material generating the wear are different. The glazed tile adopts four metal balls with diameters of 1 mm, 2 mm, 3 mm and 5 mm and a corundum wear material with a granularity of F80, and the unglazed tile adopts a steel wheel. This is unrelated to the practical using conditions, and the influence of different test methods on the surface wear resistance of the ceramic tile is obviously greater than that of pedestrians on the ceramic tile.

Second, the type of the used wear material is corundum, which is much harder than abrasive particles contacting with the ceramic tile in the practical use scenario.

Third, the evaluation standard for the result includes evaluating the glazed tile using the change in abrasion, color and gloss, and evaluating the unglazed tile using a volume loss, which is unrelated to the surface change generated by the wear. In most cases, the surface change is represented by the change in surface roughness and surface gloss. But it is still not enough to judge whether the anti-slip wear resistance of the selected ceramic tile is suitable or not through the change in the surface roughness and surface gloss after the ceramic tile used in the architectural space with large volume of people or heavy traffic is worn, and the standard and method that are tested and proved to be consistent with the required anti-slip wear resistance level are lacking at present. Therefore, the anti-slip long effectiveness standards equivalent to the wear resistance of the anti-slip tile are formulated in the embodiments of the present disclosure, the compatibility and service requirements of the product are ensured by reappearing the practical wear mechanism and evaluating the anti-slip long effectiveness performance of the wear resistance of the anti-slip ceramic tile, and meanwhile the occurrence of unnecessary accidents caused by unsuitable anti-slip ceramic tiles selected in the use space can be prevented.

The wear material in the embodiments of the present disclosure is Scotch Brite ultra-fine cleaning pad, which is similar to the material of rubber shoes in life, facilitating the long effectiveness wear test and the improvement of the authenticity of the wear test.

In one embodiment of the present disclosure, before performing the wear test on the testing surface of the to-be-tested anti-slip ceramic tile, further including: horizontally placing the to-be-tested anti-slip ceramic tile on a test board in a manner of the testing surface facing upwards; and performing an anti-slip performance test on the testing surface by using a pendulum method, to obtain an initial pendulum value; or performing an anti-slip performance test on the testing surface by using a sliding friction method, to obtain an initial sliding friction value.

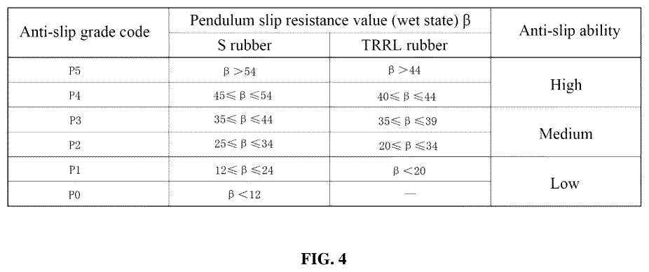

In embodiments of the present disclosure, the testing surface of the anti-slip tile is cleaned first, the to-be-tested anti-slip ceramic tile is horizontally placed on the test board in a manner of the testing surface facing upwards, the pendulum method or the sliding friction method is selected, and the initial pendulum value or the initial sliding friction value of the anti-slip ceramic tile sample is tested according to the testing standards thereof. As shown in FIG. 4, which is a standard table for determining an anti-slip grade by a pendulum method (wet state).

Specifically, the surface of the anti-slip ceramic tile is relatively rough in general, so dust, impurities, particles and other pollutants easily exist on the surface, and therefore the testing surface of the anti-slip tile needs to be cleaned. Moreover, the surface of the to-be-tested ceramic tile must be in a horizontal state, if the testing surface tilts a certain angle during test, the true anti-slip performance thereof will be affected, and therefore the test performed in the horizontal state facilitates the reduction of testing errors.

There are many kinds of methods and principles for the anti-slip test, such as, a maximum static friction method, a sliding friction method, a pendulum method and a slope critical angle method. The maximum static friction method cannot normally reflect the state that the human body moves relatively to the ground during movement; the sliding friction method is that the slider makes a uniform slip on the testing surface, and is inconsistent with the walking state in the practical life; and the slope critical angle method can reflect the state of people's toes landing in a rapid motion, but with more influence factors and relatively large errors.

In embodiments of the present disclosure, the pendulum method can be optimized to test the surface anti-slip performance of the anti-slip ceramic tile, because the 4S rubber material used by the pendulum method is close to the material of the shoe soles, and has a certain hardness and elasticity; and the motion state that people's heels land first during practical slowing walk is well simulated by the pendulum method, thus better simulating and reflecting practical situations.

Specifically, energy conversion principles are mainly adopted for the anti-slip tile tested by the pendulum method, and from the initial zero velocity, the pendulum has the potential energy converted into the kinetic energy and has a certain velocity after making a circular motion; when a rubber sheet on the pendulum is just in contact with the surface of the anti-slip tile, the rubber sheet will continue to slide a certain distance on the surface of the ceramic tile due to an inertia effect, and at this time energy loss will generate; and if an air resistance and other negligible factors are eliminated, the energy loss is the work made by the rubber sliding a certain distance on the surface of the anti-slip tile, that is, the work made by the frictional resistance. Relatively speaking, the pendulum method represents the anti-friction ability of the object surface more scientifically, and it must be noted that the surface tested by the pendulum method must be a plane, the flat the surface, and the accurate the detected data is; the data is not accurate enough if the surface is uneven, and for example, uneven and greatly fluctuated mold surfaces adopt the same anti-slip process and glaze material, the tested data has a certain difference from that of the flat surface, and the uneven and greatly fluctuated anti-slip products are not suitable for being tested by the pendulum method. The state that the pendulum rubber of the pendulum method is just in contact with the to-be-tested surface simulates the state that people's heels land first at a slow walking and relaxing state in life well. When people walk slowly, they are prone to sliding and falling accidents if the contacted surface has insufficient anti-slip performance, and most of the slow-walking crowd is the elderly.

The slope critical angle water process test is to test the tendency that people slide with the increase of a tilt angle, and tester's tiptoes will exert as the angle continues to increase. This method simulates the state that the people's tiptoes land first at fast walking in life well. But, when people walk quickly or run, they are also prone to falling if the contacted floor has insufficient anti-slip performance, and most of the fast-walking crowd is the children, young people or people in motion. In addition, an oil process test is also used for the slope critical angle; and during the oil process test, rubber safety shoes that are similar to the tire tread in a great area, and a high-viscosity oil medium are in contact with the surface of the ceramic tile. The slope critical angle test exists a certain error, the testing result has a certain subjectivity, and the repeatability of the testing result is not high as that of the pendulum method. For example, the uphill state is different from the downhill state. The pendulum method is more suitable for the flat surface, this kind of product with the relatively flat surface is more suitable for being used in most exterior walkways and hall entrances and exits with the most probable pollutant as water, and many people will wear the shoes with hard primers and worn rubber-faced patterns, which is more in line with the practical scenes of life. The slope critical angle method is more suitable for testing the greatly fluctuated surface, and regardless of the barefoot water process or the oil process with the safety rubber shoes worn, under a certain positive pressure, the soles have a certain elasticity, which will mesh with the surface with great fluctuation and high roughness, thus increasing the friction and reaching a tendency for preventing the relative slip. The product tested by the slope critical angle oil process is more suitable for commercial kitchens and industrial areas, and people in this space will wear the special rubber shoes and may encounter sticky pollutants. The tooth surfaces of the safety shoes form interlocking mesh with the surface with great fluctuation and high roughness to prevent sliding, which is not available in many kinds of shoes. Therefore, the oil process testing result of the slope critical angle may overestimate the resistance of some ceramic tiles or material surface to ordinary footwear, and the slope critical angle test method is not suitable for the ceramic tile or material surface with the flat surface and lower roughness.

The sliding friction is tested by the maximum static friction method, this test method will not appear in the practical life, and the motion state of people is not the soles and floor moving in a contact manner all the time, rather than a slip risk possibly generated when the heels or toes are just in contact with the floor.

When the product is tiled for being used, and the anti-slip long effectiveness of the anti-slip ceramic tile tested by the pendulum method and the slope method is not more convenient than that of the anti-slip ceramic tile tested by the dynamic friction coefficient method. The device can be brought to the site for the dynamic sliding friction method, without destroying the tiles, and however the pendulum method and the slope method cannot achieve the convenience of the dynamic sliding friction method in principle. Therefore, a test method for equivalent wear needs to be found for simulation, for ease of the equivalent wear by the pendulum method. After a gray grinding pad with a total counterweight of 1,000 g is used to perform the reciprocating equivalent fast wear on the ceramic tile, the ceramic tile is simultaneously tested through the pendulum method and the dynamic sliding friction method, and in combination with the previous test, the data of the two anti-slip test methods after 5,000 times of wear treatments can be obtained.

The anti-slip timeliness of the worn ceramic tile in the practical application scenarios is simulated by using the number of equivalent wear, and the association between a DCOF (Dynamic Coefficient of Friction) value of the sliding friction and a PTV (Pendulum Test Value) of the pendulum method is matched through the data acquired by the equivalent wear of the DCOF value of the sliding friction and the PTV of the pendulum method, thus obtaining the anti-slip timeliness of the ceramic tile applied in the practical scenarios. Thus, the anti-slip performance of the ceramic tile in the practical application scenarios can be tracked, the DCOF value of the sliding friction is collected at the site, and the PTV corresponding to the pendulum method can be obtained by the method for the number of equivalent wear in the laboratory, facilitating the subsequent detection and determination for the anti-slip long effectiveness of various ceramic tiles or materials applied in the practical scenarios.

Therefore, considering the practical life state and the testing accuracy and combining with the actually required anti-slip effect of the ceramic tile surface, the PTV of the pendulum method is optimized to represent the anti-slip long effectiveness of the rapidly worn ceramic tile surface. The accelerated wear device contains the record for the reciprocating motion and the counterweight pressure record for the worn sample surface, and this kind of testing mode can eliminate the influence brought by the potential subjective human factor.

In addition, the initial pendulum value refers to the pendulum numerical value of the unworn ceramic tile sample tested by the pendulum method, representing the most original anti-slip performance index when the ceramic tile is delivered.

In embodiments of the present disclosure, the most original anti-slip performance index when the ceramic tile is delivered can be obtained by testing the initial pendulum value.

In one embodiment of the present disclosure, the test method for the anti-slip long effectiveness of the anti-slip ceramic tile further includes: formulating a wear anti-slip long effectiveness grading table in advance; where the wear anti-slip long effectiveness grading table includes a plurality of anti-slip long effectiveness grade codes, as well as wear test threshold scopes and numbers of wear that correspond to the anti-slip long effectiveness grade codes. As shown in Table 1 and Table 2, Table 1 is a wear anti-slip long effectiveness grading table corresponding to a pendulum method test, and Table 2 is a wear anti-slip long effectiveness grading table corresponding to a sliding friction method test, where MPTV is a friction pendulum value, and a MCOF value is a sliding friction value.

TABLE 1

| | | | Anti-slip | | |
|---|---|---|---|---|---|
| | | | long | | |
| Serial | Grade | S rubber pendulum | effectiveness | Number | Wear equivalent |
| number | code | value (MPTV) | ability | of wear | determination |
| 1 | MP5 | MPTV ≥ 55 | High | 2000/5000 | 5 years for high-traffic |
| | | | | | restaurant entrance |
| | | | | | and exit |
| 2 | MP4 | 45 ≤ MPTV< 55 | High | 1000/2000 | 3 years for high-traffic |
| | | | | | restaurant entrance |
| | | | | | and exit |
| 3 | MP3 | 35 ≤ MPTV < 45 | Medium | 500/1000 | 2 years for high-traffic |
| | | | | | restaurant entrance |
| | | | | | and exit |
| 4 | MP2 | 25 ≤ MPTV < 35 | Medium | 100/500 | 1 year for high-traffic |
| | | | | | restaurant entrance |
| | | | | | and exit |
| 5 | MP1 | MPTV < 25 | Low | 100 | 0.5 years for high- |
| | | | | | traffic restaurant |
| | | | | | entrance and exit |

TABLE 2

| | | | Anti-slip | | |
|---|---|---|---|---|---|
| | | | long | | |
| Serial | Grade | Sliding friction | effectiveness | Number | Wear equivalent |
| number | code | (MCOF) value | ability | of wear | determination |
| 1 | MC5 | MCOF ≥ 0.60 | High | 2000/5000 | 5 year for high- |
| | | | | | traffic restaurant |
| | | | | | entrance and exit |
| 2 | MC4 | 0.54 ≤ MCOF < 0.60 | High | 1000/2000 | 3 year for high- |
| | | | | | traffic restaurant |
| | | | | | entrance and exit |
| 3 | MC3 | 0.48 ≤ MCOF < 0.54 | Medium | 500/1000 | 2 year for high- |
| | | | | | traffic restaurant |
| | | | | | entrance and exit |
| 4 | MC2 | 0.42 ≤ MCOF < 0.48 | Medium | 100/500 | 1 year for high- |
| | | | | | traffic restaurant |
| | | | | | entrance and exit |
| 5 | MC1 | MCOF < 0.42 | Low | 100 | 0.5 years for high- |
| | | | | | traffic restaurant |
| | | | | | entrance and exit |

In embodiments of the present disclosure, the anti-slip long effectiveness of the anti-slip performance of the anti-slip tile after a certain number of wear can be obtained through rapid wear and the wear anti-slip long effectiveness grading table, so as to determine whether the anti-slip tile of this technology can be used in which places, guide the enterprise to quickly obtain the equivalent method for the anti-slip long effectiveness of the anti-slip ceramic tile, and avoid the safety accidents caused by the weakened or disappeared anti-slip effect after the product is used. The anti-slip performance of the used anti-slip tile can be equivalently foreknown in advance through the method in the embodiments of the present disclosure, so as to guide technicians and production personnel to make the technical adjustment in advance, thus better guiding the technology application and production of the anti-slip ceramic tile, and stabilizing the product quality.

In one embodiment of the present disclosure, the step S100 specifically includes: performing a wear test on the testing surface of the to-be-tested anti-slip ceramic tile according to a sequence of the number of wear in the wear anti-slip long effectiveness grading table from small to large under a preset wear pressure, where the anti-slip long effectiveness grade codes are ranked according to the sequence of the number of wear from small to large.

As shown in FIG. 1, the test method for the anti-slip long effectiveness of the anti-slip ceramic tile further includes:
step S200: performing an anti-slip performance test on the worn testing surface, to obtain a wear test value.

In one embodiment of the present disclosure, the step S200 specifically includes: performing an anti-slip performance test on the worn testing surface by using a pendulum method, to obtain a wear pendulum value; or, performing an anti-slip performance test on the worn testing surface by using a sliding friction method, to obtain a wear sliding friction value.

In the embodiments of the present disclosure, the surface of the anti-slip ceramic tile after a certain number of wear is cleaned, then the pendulum value in the area of the worn surface is measured by the pendulum method, to obtain the pendulum value after wearing; or the worn testing surface is subjected to the anti-slip performance test by the sliding friction method again, to obtain the wear sliding friction value, thus determining the anti-slip long effectiveness grade of the rapidly worn anti-slip performance of the anti-slip tile with this technology.

Specifically, the repeatedly worn surface is subjected to a certain degree of wear, at this time, the middle position of the rapid wear area is selected, and the pendulum method is continuously adopted to measure the pendulum value after wearing. According to the standard of the pendulum value, if the pendulum value of the surface of the ceramic tile that is counterweighted with 1 kg and has 5,000 times of rapid reciprocating wear can reach PTV≥35, indicating that the ceramic tile still has the medium anti-slip performance, then the ceramic tile of this technology is determined to have the wear anti-slip long effectiveness, and the wear anti-slip long effectiveness grading table is set based on the standard table of FIG. 4.

As shown in FIG. 1, the test method for the anti-slip long effectiveness of the anti-slip ceramic tile further includes:
step S300: determining an anti-slip long effectiveness grade of the to-be-tested anti-slip ceramic tile according to the wear test value.

In one embodiment, the equivalent wear anti-slip timeliness of the anti-slip tile is measured by adopting the pendulum method, the anti-slip glaze technology is adopted for the anti-slip tile, with the initial pendulum value of 71, the wear area of 100 mm×300 mm and the counterweight pressure of 1 kg. The Scotch Brite ultra-fine cleaning pad serves as the wear material, after the pad is worn for 5,000 times, the PTV in the middle wear area is measured to be 45 through the pendulum method, and according to the pendulum testing standard, the anti-slip ceramic tile of this technology is determined to have the equivalent wear anti-slip long effectiveness.

In another embodiment, the equivalent wear anti-slip long effectiveness of the anti-slip tile is measured by adopting the sliding friction method, the anti-slip glaze technology is adopted for the anti-slip tile, with the initial sliding friction coefficient of 0.82, the wear area of 100 mm×300 mm and the counterweight pressure of 1 kg. The Scotch Brite ultra-fine cleaning pad serves as the wear material, after the pad is worn for 5,000 times, the DCOF in the middle wear area is measured to be 0.63 through the sliding friction method, and according to the sliding friction test and determination standard, the anti-slip tile of DCOF≥0.42 has higher safety, and the anti-slip tile of this technology is determined to have the equivalent wear anti-slip long effectiveness. According to the anti-slip test and anti-slip grade determination standards of the friction coefficient method, the static friction coefficient of the floor and corridor in all business places facing the public shall be 0.60 or above, and the slope shall be 0.80 or above. The friction coefficient of less than 0.4 is a high risk, the friction coefficient of greater than or equal to 0.4 and less than 0.6 is a medium risk, and the friction coefficient of greater than or equal to 0.6 is a low risk.

In one embodiment of the present disclosure, the step S3 specifically includes:
step S310: searching the wear anti-slip long effectiveness grading table, and determining a target anti-slip long effectiveness grade code and a target wear test threshold scope that correspond to the current number of wear in the wear anti-slip long effectiveness grading table; and
step S320a: recording the target anti-slip long effectiveness grade code and the current number of wear as the anti-slip long effectiveness grade of the to-be-tested anti-slip ceramic tile if the wear test value is within the target wear test threshold scope.

For example, as shown in Table 1 and Table 2, when the wear test is performed at the number of wear of 100, 500, 1,000, 2,000, 5,000 in turn, 100 times of reciprocating wear are performed first, then the anti-slip performance test is performed to obtain the test result, the corresponding test threshold scope when the number of wear is 100 is obtained by searching the wear anti-slip long effectiveness grading table, the wear test is stopped if the test result is within the test threshold scope, and the anti-slip long effectiveness grade code corresponding to the number of wear and the number of wear are denoted as the anti-slip long effectiveness grade together.

In one embodiment of the present disclosure, after the step S310, further including:
step S321b: the number of wear corresponding to the next anti-slip long effectiveness grade code serving as a target number of wear if the wear test value is higher than the target wear test threshold scope;
step S322b: performing the wear test on the testing surface of the to-be-tested anti-slip ceramic tile until to reach the target number of wear under the preset wear pressure; and
step S323b: performing an anti-slip performance test on the testing surface of the to-be-tested anti-slip ceramic tile that reaches the target number of wear.

In embodiments of the present disclosure, if the test result is not within the test threshold scope and higher than the test threshold scope, the wear test is required continuously; and for example, the number of wear is increased from 100 to 500, that is, 400 times of reciprocating wear are continued.

In one embodiment of the present disclosure, after the step S310, further including: recording the target anti-slip long effectiveness grade code and the previous number of wear of the current number of wear as the anti-slip long effectiveness grade of the to-be-tested anti-slip ceramic tile if the wear test value is lower than the target wear test threshold scope.

In embodiments of the present disclosure, if the test result is not within the test threshold scope and lower than the test threshold scope, the wear test is stopped, and the wear anti-slip long effectiveness grading table is searched; and the anti-slip long effectiveness grade code corresponding to the number of wear and the previous number of wear corresponding to the number of wear are denoted as the anti-slip long effectiveness grade.

In one embodiment of the present disclosure, the wear anti-slip long effectiveness grading table includes: a wear anti-slip long effectiveness grading table corresponding to a pendulum method test and/or a wear anti-slip long effectiveness grading table corresponding to a sliding friction method test.

Specifically, in the present disclosure, the anti-slip value after wearing is measured by the pendulum method, or the anti-slip value after wearing is measured by the sliding friction method, the two methods correspond to the wear anti-slip long effectiveness grading table, and the two tables can be saved simultaneously or only one table can be saved.

In one embodiment of the present disclosure, the wear anti-slip long effectiveness grading table further includes: an anti-slip long effectiveness ability and/or a wear equivalent determination result corresponding to the anti-slip long effectiveness grade code.

In embodiments of the present disclosure, the anti-slip long effectiveness ability and/or the wear equivalent determination result are also marked in the wear anti-slip long effectiveness grading table, for ease of finding the corresponding anti-slip long effectiveness ability and the wear equivalent determination result by the technicians, thus guiding the technicians and production personnel, and making the technical adjustment in advance.

Description is made below with specific embodiments.

### Embodiment I

Testing samples are prepared according to the national standard GBT37798-2019 appendix B and sliding friction method ANSI A137.1:2012 DCOF standards. Both the testing samples are tested in a damp state, and the rapid wear test is performed in a dry state.

The Scotch Brite ultra-fine cleaning pad serves as the wear material, and when the wear material has the number of reciprocating wear reaching 20,000 times, the rapid wear material of the same mode shall be replaced again. After being subjected to 50 times of reciprocating wear on a dried testing surface, the new rapid wear material can be used for testing.

A to-be-tested surface of each testing sample has an external dimension of not less than 80 mm×130 mm (the pendulum S rubber is 76.2 mm long, and the distance that the S rubber slides across the testing surface is 126 mm), there are five testing samples, and the surface should be cleaned and dried.

The specific steps for testing the sample include:
step A1: testing according to the national standard GBT37798-2019 appendix B or sliding friction method ANSI A137.1:2012 DCOF standards, acquiring an initial PTV value and a DCOF value of the sample, and testing five samples of the same technology;
step A2: adjusting the level of a rapid wear instrument, checking whether or not the wear material needs to be replaced;
step A3: mounting and fixing the to-be-tested sample, and checking whether or not the sample is mounted firmly and flatly;
step A4: setting a wear pressure as 1,000 g;
step A5: setting the number of rapid wear, and setting as 100 times from a sequence from low to high;
step A6: performing rapid wear on the sample surface until reaching the set number of wear, and ending the wear;
step A7: taking out the worn sample, testing according to the national standard GBT37798-2019 appendix B or sliding friction method ANSI A137.1:2012 DCOF standards, and acquiring a wear anti-slip MPTV value or a MCOF value of the worn sample;
step A8: continuing to test the remaining four samples, to obtain the wear anti-slip MPTV value or the MCOF value; and
step A9: solving an average value of the MPTV value or MCOF value of the five tested samples, representing the anti-slip performance of the actually worn sample, and determining the anti-slip timeliness of the worn sample in combination with two kinds of grading tables.

When adopting the pendulum method, the specific steps for determining the sample include:
step B1: when the MPTV value<25 after 100 times of wear, finally determining the long effectiveness grade of the sample as MP1, the anti-slip long effectiveness ability being low, and marked as MP1-100;
step B2: when the MPTV value≥25 after 100 times of wear, continuing the wear test, and increasing the number of wear from 100 to 500; after 500 times of wear, if 25≤MPTV<35, finally determining the long effectiveness grade of the sample as MP2, the anti-slip long effectiveness ability being medium, marked as MP2-500; and marking the anti-slip long effectiveness grade as MP2-100 if the MPTV value is less than 25;
step B3: when the MPTV value≥35 after 500 times of wear, continuing the wear test, and increasing the number of wear from 500 to 1,000; if 35≤MPTV<45, finally determining the long effectiveness grade of the sample as MP3, the anti-slip long effectiveness ability being medium, marked as MP3-1,000, and marking the anti-slip long effectiveness grade as MP3-500 if the MPTV value is less than 35;
step B4: when the MPTV value≥45 after 1,000 times of wear, continuing the wear test, and increasing the number of wear from 1,000 to 2,000; if 45≤MPTV<55, finally determining the long effectiveness grade of the sample as MP4, the anti-slip long effectiveness ability being high, marked as MP4-2,000, and marking the anti-slip long effectiveness grade as MP4-1,000 if the MPTV value is less than 45;
step B5: when the MPTV value≥55 after 2,000 times of wear, continuing the wear test, and increasing the number of wear from 2,000 to 5,000; if MPTV≥55, finally determining the long effectiveness grade of the sample as MP5, the anti-slip long effectiveness ability being high, marked as MP5-5,000, and marking the anti-slip long effectiveness grade as MP5-2,000 if the MPTV value is less than 55.

When adopting the sliding friction method, the specific steps for determining the sample include:
step C1: when the MCOF value<0.42 after 100 times of wear, finally determining the long effectiveness grade of the sample as MC1, with a low anti-slip long effectiveness ability, marked as MC1-100;
step C2: when the MCOF value≥0.42 after 100 times of wear, continuing the wear test, and increasing the number of wear from 100 to 500; after 500 times of wear, if 0.42≤MCOF<0.48, finally determining the long effectiveness grade of the sample as MC2, the anti-slip long effectiveness ability being medium, marked as MC2-500, and marking the anti-slip long effectiveness grade as MC2-100 if the MCOF value is less than 0.42;
step C3: when the MCOF value≥0.48 after 500 times of wear, continuing the wear test, and increasing the number of wear from 500 to 1,000; if 0.48≤MCOF<0.54, finally determining the long effectiveness grade of the sample as MC3, the anti-slip long effectiveness ability being medium, marked as MC3-1,000, and marking the anti-slip long effectiveness grade as MC3-500 if the MCOF value is less than 0.48;
step C4: when the MCOF value≥0.54 after 1,000 times of wear, continuing the wear test, and increasing the number of wear from 1,000 to 2,000; if 0.54≤MCOF<0.6, finally determining the long effectiveness grade of the sample as MC4, the anti-slip long effectiveness ability being high, marked as MC4-2,000, and marking the anti-slip long effectiveness grade as MC4-1,000 if the MCOF value is less than 0.54; and
step C5: when the MCOF value≥0.6 after 2,000 times of wear, continuing the wear test, and increasing the number of wear from 2,000 to 5,000; if MCOF≥0.6, finally determining the long effectiveness grade of the sample as MC5, the anti-slip long effectiveness ability being high, marked as MC5-5,000, and marking the anti-slip long effectiveness grade as MC5-2,000 if the MCOF value is less than 0.6.

### Embodiment II

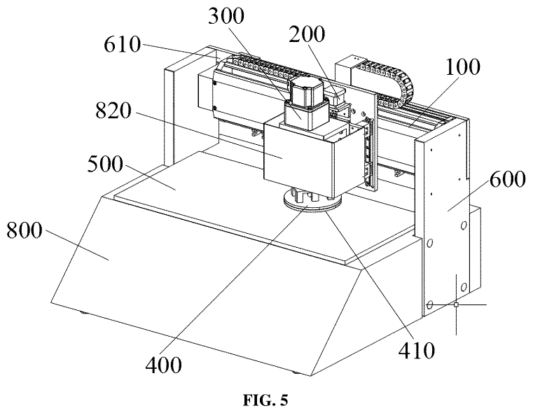

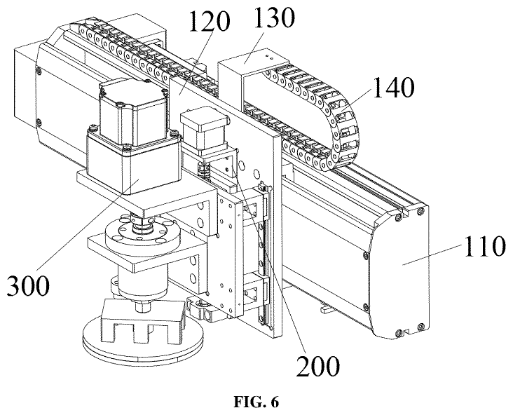

The accelerated wear device used in embodiments of the present disclosure is as shown in FIG. 5 and FIG. 6, including an X-axis drive mechanism 100, a Z-axis drive mechanism 200, a rotary friction mechanism 300 and an abrasive tool seat 400. The Z-axis drive mechanism 200 is disposed on the X-axis drive mechanism 100, the rotary friction mechanism 300 is disposed on the Z-axis drive mechanism 200, and the abrasive tool seat 400 is disposed on the rotary friction mechanism 300. The abrasive tool seat 400 is used for mounting a wearing part 410, and drives the wearing part 410 to perform a friction motion with a to-be-tested ceramic tile 500 under the drive of the X-axis drive mechanism 100, the Z-axis drive mechanism 200 and the rotary friction mechanism 300.

In embodiments of the present disclosure, arranging the X-axis drive mechanism 100, Z-axis drive mechanism 200, rotary friction mechanism 300 and abrasive tool seat 400 enables the abrasive tool seat 400 to drive the wearing part 410 to perform the friction motion with the to-be-tested ceramic tile 500 under the drive of the X-axis drive mechanism 100, the Z-axis drive mechanism 200 and the rotary friction mechanism 300, thus achieving the rapid wear of the to-be-tested ceramic tile 500, and then determining the anti-slip performance of the worn ceramic tile.

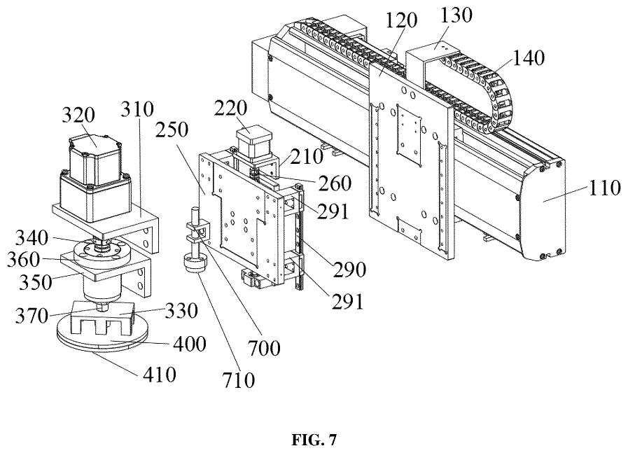

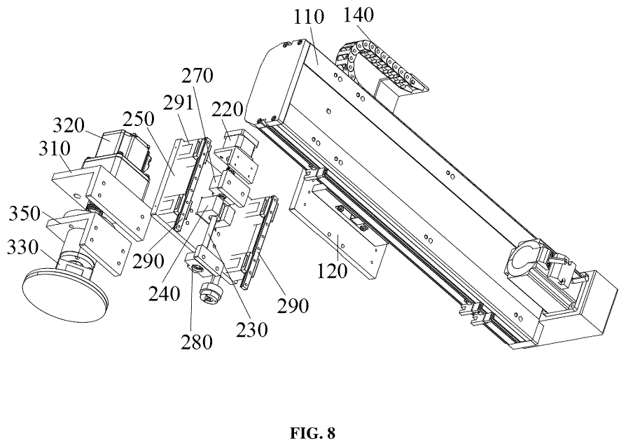

In one embodiment of the present disclosure, the accelerated wear device further includes a linear mechanism fixed frame 600 and a linear mechanism back plate 610 disposed on the linear mechanism fixed frame 600, and the X-axis drive mechanism 100 is disposed on the linear mechanism back plate 610. As shown in FIG. 7 and FIG. 8, the X-axis drive mechanism 100 includes a single-axis linear drive member 110, a vertical mechanism back plate 120, a tow chain fastener 130 and a tow chain 140. The single-axis linear drive member 110 is fixed to the linear mechanism back plate 610, the vertical mechanism back plate 120 is slidingly connected to the single-axis linear drive member 110, and the tow chain fastener 130 is fixed to the vertical mechanism back plate 120; and one end of the tow chain 140 is fixed to the single-axis linear drive member 110 while the other end is connected with the tow chain fastener 130, and the tow chain 140 is fitted in parallel to the single-axis linear drive member 110, to guide the tow chain fastener 130.

Specifically, the single-axis linear drive member 110 has a drive motor, and the tow chain 140 has a guide effect. The X-axis drive mechanism 100 provided by embodiments of the present disclosure has a high transmission efficiency, and can reduce the energy loss and improve the whole efficiency of mechanical equipment.

In one embodiment of the present disclosure, the Z-axis drive mechanism 200 includes a motor base 210, a stepping motor 220, a ball screw 230, a lead screw nut bracket 240 and a rotary mechanism back plate 250. The motor base 210 is fixed to one side of the vertical mechanism back plate 120 that deviates from the single-axis linear drive member 110, the stepping motor 220 is fixed to the motor base 210, the ball screw 230 is connected with an output shaft of the stepping motor 220, the lead screw nut bracket 240 is sleeved on the ball screw 230, and the rotary mechanism back plate 250 is fixedly connected with the lead screw nut bracket 240.

Specifically, the stepping motor 220 provides a rotary motion that is transferred to the ball screw 230, and when the ball screw 230 rotates, the rotary monition of the ball screw 230 is converted into a linear motion of a nut. Therefore, the ball screw 230 achieves the conversion from the rotary motion to the linear motion, and can perform high-speed forward and reverse transmission steadily and improve the motion stability of the accelerated wear device in a Z-axis direction.

In one embodiment of the present disclosure, the Z-axis drive mechanism 200 further includes a first coupling 260, a fixed-side bearing seat 270 and a supported-side bearing seat 280. The ball screw 230 is connected with the output shaft of the stepping motor 220 through the first coupling 260, and both the fixed-side bearing seat 270 and the supported-side bearing seat 280 are disposed on the vertical mechanism back plate 120. The ball screw 230 includes a fixed side and a supported side, the fixed-side bearing seat 270 is used for supporting the fixed side of the ball screw, and the supported-side bearing seat 280 is used for supporting the supported side of the ball screw.

Specifically, the vertical mechanism back plate 120 may also be provided with base plates of the fixed-side bearing seat 270 and the supported-side bearing seat 280, the fixed-side bearing seat 270 is disposed on the base plate of the fixed-side bearing seat 270, and the supported-side bearing seat 280 is disposed on the base plate of the supported-side bearing seat 280.

The coupling is a component through which the output shaft of the motor is connected with the ball screw 230, and mainly functions in transferring the rotary motion of the motor to the ball screw 230, thus achieving the rotation of the ball screw 230; and moreover the coupling can absorb an axis deviation (such as eccentricity, deflection and axial displacement) between rotating bodies, which helps reduce the vibration and noise caused by mounting or manufacturing errors, and improves the system stability and reliability.

The bearing seat is a component for mounting the bearing of the ball screw 230, and provides stable supporting and accurate positioning, to ensure that the ball screw 230 remains the accurate axis direction during rotation; and moreover, the bearing seat can bear various loads generated by the ball screw 230 during transmission. A bearing seat base plate can be disposed on the vertical mechanism back plate 120, such that the bearing seat is fixed to the bearing seat base plate.

In one embodiment of the present disclosure, the Z-axis drive mechanism 200 further includes a linear guide rail 290 and a linear slider 291. The linear guide rail 290 is fixed to one side of the vertical mechanism back plate 120 that deviates from the single-axis linear drive member 110; the linear slider 291 is disposed on the linear guide rail 290 and connected with the rotary mechanism back plate 250, and the linear guide rail 290 is set in parallel to the ball screw 230.

Specifically, the linear guide rail 290 may also be provided with a linear slider 291 gasket, and the linear slider 291 is disposed on the linear slider 291 gasket. Since both the ball screw 230 and the linear guide rail 290 have the characteristic of high precision, the ball screw 230 achieves the high-efficiency transmission through ball rolling and has the high precision and high load capacity, the linear guide rail 290 provides the accurate guidance for the linear motion, and the cooperative use of the ball screw 230 and the linear guide rail 290 in embodiments of the present disclosure can further improve the whole positioning precision of the device. Moreover, the linear guide rail 290 provides the stable support to the ball screw 230, which helps reduce the vibration and deflection of the screw during transmission, and under a working condition of high speed or high load, the linear guide rail 290 can remain better dynamic response and rigidity, to ensure the stable motion without fluctuation of the ball screw 230. The linear guide rail 290 can also bear some axial and radial loads generated by the ball screw 230 during transmission, thus easing the burden of the screw and prolonging the service life thereof.

In one embodiment of the present disclosure, two linear guide rails 290 are provided and located on both sides of the ball screw 230 in respective, two linear sliders 291 are disposed on each linear guide rail 290, and various linear sliders 291 are all connected with the rotary mechanism back plate 250.

In embodiments of the present disclosure, the linear guide rails 290 are disposed on both sides of the ball screw 230, which can significantly improve the positioning precision, stability, bearing capacity and motion control efficiency of the device.

In one embodiment of the present disclosure, the rotary friction mechanism 300 includes a motor fixed seat 310, a brushless motor 320, a rotating shaft and an abrasive tool seat connector 330. The motor fixed seat 310 is disposed on the rotary mechanism back plate 250, the brushless motor 320 is disposed on the motor fixed seat 310, and the rotating shaft is connected with an output shaft of the brushless motor 320; and the abrasive tool seat connector 330 is disposed at one end of the rotating shaft that deviates from the brushless motor 320, and the abrasive tool seat connector 330 is used for connecting the abrasive tool seat 400.

Specifically, an output shaft of the brushless motor 320 is connected with the rotating shaft by adopting a second coupling 340. The rotary mechanism back plate 250 is also provided with a spindle bearing fixed seat 350, and a spindle bearing 360 is fixed to the spindle bearing fixed seat 350. The bearing mainly functions in reducing the friction between rotating components, making the rotating shaft rotate more smoothly, thus reducing the energy consumption and improving the operating efficiency of the mechanical equipment. The rotating shaft is also sleeved with a precise locking nut 370, the precise locking nut 370 can effectively fix the rotating shaft, bearing and other components, to ensure that these components will not be loosened or fall during rotation, thus improving the operating safety and reliability of the mechanical equipment.

In one embodiment of the present disclosure, the rotary mechanism back plate 250 is also provided with a pressure sensor fixed frame 700, on which a pressure sensor 710 is disposed, and the pressure sensor 710 is used for detecting the pressure of the to-be-tested ceramic tile 500.

Specifically, the pressure sensor fixed frame 700 includes a pressure sensor 710 fixed seat disposed on the rotary mechanism back plate 250 and a pressure sensor 710 fixed rod disposed on the pressure sensor 710 fixed seat, the pressure sensor 710 is disposed on the pressure sensor 710 fixed seat, and a clamping gear may be set between the fixed rod and the fixed seat. Thus, both the pressure sensor 710 and the wearing part 410 provided with the wear material can be in contact with the tile surface, the Z-axis drive mechanism 200 moves downward slowly such that the friction material and the pressure sensor 710 generate a certain pressure to the tile, the numerical value of the pressure sensor 710 is recorded, and the pressure sensor 710 is lifted. For example, the pressure sensor 710 is lifted to the previous gear.

In embodiments of the present disclosure, the degree of wear caused to the tile surface when the same person treads and rubs the tile surface for many times is simulated by changing the number of reciprocating and rotating speed of the device in a case that the pressure of the wear material to the tile surface is fixed by arranging the pressure sensor 710, and the degree of wear on the surface of the to-be-tested object can be rapidly simulated through pressure regulation.

In one embodiment of the present disclosure, the accelerated wear device further includes a device base 800, the linear mechanism fixed frame 600 is erected on the device base 800, an upper end face of the device base 800 is also provided with a ceramic tile fixed area, and the ceramic tile fixed area is located below the rotary friction mechanism 300 to fix the to-be-tested ceramic tile 500.

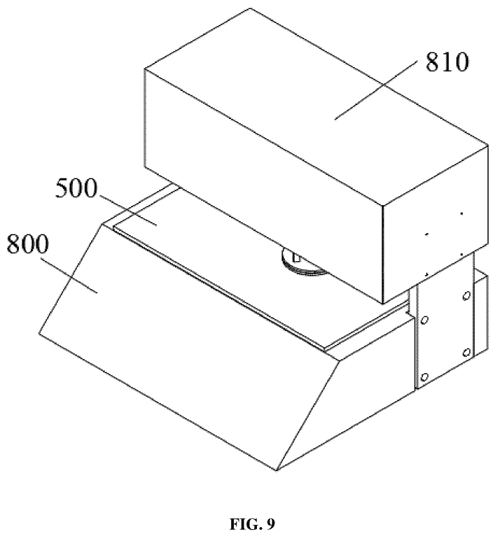

Specifically, four corners of the device base 800 that are in contact with the floor are provided with floor mats, which helps improve the whole stability of the device. In addition, as shown in FIG. 9, in embodiments of the present disclosure, an outer cover 810 and a protective cover 820 are disposed above the device base 800, making the device more safe and beautiful.

The present disclosure provides a test method for anti-slip long effectiveness of an anti-slip ceramic tile. The test method includes: performing a wear test on a testing surface of a to-be-tested anti-slip ceramic tile; performing an anti-slip performance test on the worn testing surface, to obtain a wear test value; and determining an anti-slip long effectiveness grade of the to-be-tested anti-slip ceramic tile according to the wear test value. In the present disclosure, the worn to-be-tested anti-slip ceramic tile is subjected to the anti-slip performance test, to obtain the anti-slip long effectiveness grade, thus explaining the performance of the worn anti-slip ceramic tile, which is conductive to the improvement and rational utilization of the anti-slip ceramic tile.

It is understood that the application of the present disclosure is not limited to the above examples, those of ordinary skill in the art can make improvements or changes according to the above specification. However, these improvements or changes fall in the protection scope of the claims of the present disclosure.

What is claimed is:

1. A test method for anti-slip long effectiveness of an anti-slip ceramic tile, comprising:
performing a wear test on a testing surface of a to-be-tested anti-slip ceramic tile;
performing an anti-slip performance test on the worn testing surface, to obtain a wear test value; and
determining an anti-slip long effectiveness grade of the to-be-tested anti-slip ceramic tile according to the wear test value.

2. The test method for the anti-slip long effectiveness of the anti-slip ceramic tile according to claim 1, wherein before performing the wear test on the testing surface of the to-be-tested anti-slip ceramic tile, and the method further comprises:
horizontally placing the to-be-tested anti-slip ceramic tile on a test board in a manner of the testing surface facing upwards; and
performing an anti-slip performance test on the testing surface by using a pendulum method, to obtain an initial pendulum value; or, performing an anti-slip performance test on the testing surface by using a sliding friction method, to obtain an initial sliding friction value.

3. The test method for the anti-slip long effectiveness of the anti-slip ceramic tile according to claim 1, further comprising:
formulating a wear anti-slip long effectiveness grading table in advance;
wherein the wear anti-slip long effectiveness grading table comprises a plurality of anti-slip long effectiveness grade codes, as well as wear test threshold scopes and numbers of wear that correspond to the anti-slip long effectiveness grade codes.

4. The test method for the anti-slip long effectiveness of the anti-slip ceramic tile according to claim 3, wherein performing the wear test on the testing surface of the to-be-tested anti-slip ceramic tile comprises:
performing a wear test on the testing surface of the to-be-tested anti-slip ceramic tile according to a sequence of the number of wear in the wear anti-slip long effectiveness grading table from small to large under a preset wear pressure;
wherein the anti-slip long effectiveness grade codes are ranked according to the sequence of the number of wear from small to large.

5. The test method for the anti-slip long effectiveness of the anti-slip ceramic tile according to claim 4, wherein determining the anti-slip long effectiveness grade of the to-be-tested anti-slip ceramic tile according to the wear test value comprises:
searching the wear anti-slip long effectiveness grading table, and determining a target anti-slip long effectiveness grade code and a target wear test threshold scope that correspond to the current number of wear in the wear anti-slip long effectiveness grading table;
wherein if the wear test value is within the target wear test threshold scope, the target anti-slip long effectiveness grade code and the current number of wear are recorded as the anti-slip long effectiveness grade of the to-be-tested anti-slip ceramic tile.

6. The test method for the anti-slip long effectiveness of the anti-slip ceramic tile according to claim 5, wherein after searching the wear anti-slip long effectiveness grading table, and determining the target anti-slip long effectiveness grade code and the target wear test threshold scope that correspond to the current number of wear in the wear anti-slip long effectiveness grading table, the method further comprises:
the number of wear corresponding to the next anti-slip long effectiveness grade code serving as a target number of wear if the wear test value is higher than the target wear test threshold scope;
performing the wear test on the testing surface of the to-be-tested anti-slip ceramic tile continuously until to reach the target number of wear under the preset wear pressure; and
performing an anti-slip performance test on the testing surface of the to-be-tested anti-slip ceramic tile that reaches the target number of wear.

7. The test method for the anti-slip long effectiveness of the anti-slip ceramic tile according to claim 5, wherein after searching the wear anti-slip long effectiveness grading table, and determining the target anti-slip long effectiveness grade code and the target wear test threshold scope that correspond to the current number of wear in the wear anti-slip long effectiveness grading table, the method further comprises:
recording the target anti-slip long effectiveness grade code and the previous number of wear of the current number of wear as the anti-slip long effectiveness grade of the to-be-tested anti-slip ceramic tile if the wear test value is lower than the target wear test threshold scope.

8. The test method for the anti-slip long effectiveness of the anti-slip ceramic tile according to claim 3, wherein the wear anti-slip long effectiveness grading table comprises: a wear anti-slip long effectiveness grading table corresponding to a pendulum method test and/or a wear anti-slip long effectiveness grading table corresponding to a sliding friction method test.

9. The test method for the anti-slip long effectiveness of the anti-slip ceramic tile according to claim 3, wherein the wear anti-slip long effectiveness grading table further comprises: an anti-slip long effectiveness ability and/or a wear equivalent determination result corresponding to the anti-slip long effectiveness grade code.

10. The test method for the anti-slip long effectiveness of the anti-slip ceramic tile according to claim 1, wherein performing the anti-slip performance test on the worn testing surface, to obtain the wear test value comprises:
performing an anti-slip performance test on the worn testing surface by using a pendulum method to obtain a wear pendulum value; or
performing an anti-slip performance test on the worn testing surface by using a sliding friction method to obtain a wear sliding friction value.
